(19) United States
(12) Patent Application Publication
(10) Pub. No.: US 2010/0106380 A1
(43) Pub. Date: Apr. 29, 2010

(54) ARTICULATING BASE FLAPS FOR AERODYNAMIC BASE DRAG REDUCTION AND STABILITY OF A BLUFF BODY VEHICLE

(76) Inventors: Kambiz Salari, Livermore, CA (US); Jason M. Ortega, Pacifica, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(21) Appl. No.: 12/608,914

(22) Filed: Oct. 29, 2009

Related U.S. Application Data
(60) Provisional application No. 61/109,432, filed on Oct. 29, 2008.

(51) Int. Cl. B62D 35/00

(52) U.S. Cl. 701/49; 296/180.5

(57) ABSTRACT

An aerodynamic base drag reduction and stability control apparatus and method uses a plurality of articulable base flaps each hingedly connected near one of a left side edge, a right side edge, a top side edge, and a bottom side edge of a rear end base of a vehicle so that each of the base flaps have a corresponding range of motion between a first position subject to direct impingement by a free stream adjacent the vehicle in motion and a second position not subject to direct impingement by the free stream. And a controller independently actuates the base flaps to corresponding desired positions relative to the free stream and within the corresponding ranges of motion to produce a desired combined aerodynamic drag reducing and/or stabilizing effect on the vehicle in motion.

### CLAIM OF PRIORITY IN PROVISIONAL APPLICATION

This application claims priority in provisional application filed on Oct. 29, 2008, entitled “Aerodynamic Drag and Stability Control of a Heavy Vehicle Through the Use of Articulating Base Flaps” Ser. No. 61/109,432, by Kambiz Salari et al, and incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to aerodynamic drag reduction methods. The invention relates more particularly to articulating base flaps for aerodynamic base drag reduction and stability control of a bluff body vehicle.

### BACKGROUND OF THE INVENTION

It is well known in the art of vehicle design that the fuel consumption of a vehicle associated with its movement is directly related to certain aerodynamic characteristics of the vehicle, such as the aerodynamic drag of the vehicle expressed as the drag coefficient, C_{d}. As the aerodynamic drag experienced by a vehicle increases, the fuel costs also correspondingly increase due to the greater energy required to overcome the drag. For example, for a vehicle traveling 70 mph on a roadway, approximately 65% of the total fuel consumption of its engine is used to overcome aerodynamic drag. Thus, even a slight reduction in the aerodynamic drag coefficient of the vehicle can result in a significant improvement in fuel economy.

Bluff bodies in particular are known to have high drag coefficients due to the presence of a recirculation zone in the wake thereof, and the relatively lower pressures acting as a consequence on the rear base of the trailing end. Bluff bodies are characteristically blunt-ended, non-streamlined moving bodies having a relatively large base surface at a trailing end which causes the large recirculation zone in the wake of the bluff body to produce the base drag. And the base surface of a bluff body vehicle is typically of a type oriented substantially normal to a free stream, as is commonly seen in tractor-trailer arrangements. This arrangement creates a sharp separation of the flow stream at the edge of base surface and thereby lowers the pressure on the base surface to produce the base drag. The drag which results from the blunt-ended trailing ends of bluff bodies is commonly known as “aerodynamic base drag.”

Numerous attempts have been made over the years to reduce the aerodynamic base drag of blunt-ended bluff bodies, especially land-based vehicles such as tractor-trailers (“semi-trailers”) and trailer vans having tall and wide profiles with a flat vertical base surface at a trailing end. Some of the proposed concepts are passive and include such implements as boattail plates, rounding the rear corners of the vehicle near its base, and streamlining the rear of the vehicle with gives or wedges. Other proposed concepts are active, such as plumbing systems that inject or release air near the rear corners of the vehicle or acoustic systems that actively perturb the flow coming off the rear of the vehicle. Some example prior developments are shown in U.S. Pat. Nos. 4,682,808, 5,498,059, 6,286,894B1, and U.S. Patent Publication No. US2002/0030384A1. These examples illustrate variations on improving aerodynamics by reducing the aerodynamic base drag experienced by tractor-trailers having a substantially flat base surface at the trailing end.

Furthermore, the stability of such bluff bodied vehicle is often more dramatically affected by various operating/travel conditions, such as for example side forces due to cross-flowing side winds, lift forces, and by in-motion vehicle body dynamics such as yaw, pitch, and rolling moments, due to their tall and wide profiles.

The need for reducing the aerodynamic drag and increasing stability control of bluff body vehicles, especially land-based vehicles traveling at highway speeds, for example, is compelling and widely recognized. It would therefore be advantageous to provide a simple cost-effective aerodynamic drag reduction and stability control apparatus for use on such bluff bodies, for improving performance and safety.

### SUMMARY OF THE INVENTION

One aspect of the present invention includes an aerodynamic base drag reduction and stability control apparatus comprising: an articulable base flap hingedly connected near an edge of a rear end base of a vehicle; and a controller operably connected to actuate the base flap to a desired position relative to a free stream adjacent the vehicle in motion to produce a desired aerodynamic drag reducing and/or stabilizing effect on the vehicle in motion.

Another aspect of the present invention includes an aerodynamic base drag reduction and stability control apparatus comprising: a plurality of articulable base flaps each hingedly connected near one of a left side edge, a right side edge, a top side edge, and a bottom side edge of a rear end base of a vehicle so that each of the base flaps have a corresponding range of motion between a first position subject to direct impingement by a free stream adjacent the vehicle in motion and a second position not subject to direct impingement by the free stream; and a controller operably connected to independently actuate the base flaps to corresponding desired positions relative to the free stream and within the corresponding ranges of motion to produce a desired combined aerodynamic drag reducing and/or stabilizing effect on the vehicle in motion.

Another aspect of the present invention includes a method of reducing aerodynamic base drag on and/or controlling stability of a bluff body vehicle, comprising: providing an articulable base flap hingedly connected near an edge of a rear end base of a vehicle, and a controller operably connected to actuate the base flap; and actuating the base flap with the controller to a desired position relative to a free stream adjacent the vehicle in motion to produce a desired aerodynamic drag reducing and/or stabilizing effect on the vehicle when in motion.

Another aspect of the present invention includes a method of reducing aerodynamic base drag and/or controlling stability of a bluff body vehicle, comprising: providing a plurality of articulable base flaps each hingedly connected near one of a left side edge, a right side edge, a top side edge, and a bottom side edge of a rear end base of a vehicle so that each of the base flaps have a corresponding range of motion between a first position subject to direct impingement by a free stream adjacent the vehicle in motion and a second position not subject to direct impingement by the free stream, and a controller for independently actuating the base flaps; and independently actuating the base flaps with the controller to corresponding desired positions relative to the free stream and within the corresponding ranges of motion to produce a desired combined aerodynamic drag reducing and/or stabilizing effect on the vehicle in motion.

Generally, the present invention is directed to a set of articulating base flaps (at least one) for controlling the aerodynamic drag and stability of a heavy bluff body vehicle such as a semi-trailer, i.e. reducing aerodynamic drag and enhancing stability. The base flaps are each hingedly connected near one of the edges of a rear end base of the vehicle, and having a range of motion that preferably extends between a position that is subject to direct impingement by a free stream adjacent the vehicle, and a position that is not subject to direct impingement by the free stream (e.g. fully retracted adjacent the base surface or side surface). By independently controlling the deflection of each of these base flaps with a controller (e.g. a hydraulic system) the drag, side, and lift forces, as well as the yaw, pitch, and rolling moments can be controlled to optimize the performance of the vehicle in motion under a wide range of free stream conditions. It is appreciated that a free stream is the stream of fluid outside the region affected by a body in the fluid, as is the case for a vehicle body in motion, and is illustrated at 418 in FIG. 4.

Each base flap has a flat, rigid-body construction that is generally constructed from a rigid material, such as any variety of lightweight rigid plastics, sheet metals, fiberglass, other composites, etc. known in the art. It is appreciated that the base flap construction may be optimized in various ways such as by changing the dimensions, contour, ribbed-reinforcement, etc., using such methods as computational fluid dynamics (CFD) simulation methods or other methods known in the art. And each base flap is hingedly connected near an edge of a rear end base of a bluff body vehicle, such as a left side edge, a right side edge, a top side edge, and a bottom side edge, where the left side edge joins the base with the left side of the vehicle body, the right side edge joins the base with the right side of the vehicle body, the top side edge joins the base with the top side of the vehicle body, and the bottom side edge joins the base with the bottom side of the vehicle body. It is appreciated that “near an edge” can include, for example, positions directly on and aligned with the edge, or positions mounted on the rear end base surface adjacent an edge thereof. In any case, the hinge connection of the base flaps near an edge of the rear end base can be implemented using various types of common mounting hardware known in the art for hinged mountings.

The “controller” of the present invention is generally a control system which includes at the very least a processor and an actuation device, and can include various mechanical/electrical systems known in the art for actuation. For example, a hydraulic system may be used as the controller of the present invention, comprising hydraulic actuator arms and a hydraulics controller/processor (e.g. computer processor/system, IC, etc.) for controlling the actuator arms. Another example is an electric actuator system with electric servos, connector arms, and servo controller (e.g. receiver if remote controlled). Or a solenoid based actuation may be employed. In any case, the controller is operably connected to each of the base flaps to independently actuate the flaps, and coordinate the independent actuations of the flaps where more than one is provided, to produce a desired aerodynamic drag reducing or stabilizing effect on the vehicle in motion.

By independently controlling each of these base flaps with the controller, the performance of the heavy vehicle can be tailored for a wide variety of operating conditions/functions. For example, the set of articulable base flaps may be controlled in various exemplary operational modes as follows having specific base flap positions, but it is appreciated that other base flap positions are equally possible:

In an “air brake mode”, all the base flaps are deflected to an outwardly directed orthogonal position that is orthogonal/normal to the free stream and is subject to direct impingement by the free stream. This mode is intended for maximizing the drag coefficient of a heavy vehicle in an emergency stop.

In a “highway travel mode,” where aerodynamic base drag minimization is desired at highway speeds, the base flaps are angled slightly inward (inwardly-directed angled position) toward a central longitudinal axis of the vehicle and away from the adjacent free stream.

In an “asymmetric stability control mode,” cross-flow conditions can be addressed by deploying the base flaps an asymmetric manner, e.g. left-side edge mounted base flaps are deflected in the same direction as right-side edge mounted base flaps, so as to enhance the stability of the moving vehicle. Alternatively, an asymmetric configuration may be produced by deflecting top and bottom-side edge mounted base flaps in the same direction.

And in a “cargo access mode,” access to the cargo area of a trailer may be provided during loading and unloading by retracing the base flaps to be flush with the trailer base surface, or flush with the trailer top, sides and bottom, which in either case places the flap in a position not subject to direct free stream impingement.

It is also appreciated that while the conventional semi-trailer truck is used herein as a representative vehicle and an exemplary application to illustrate functionality and mounting arrangements of the present invention, the apparatus and method of the present invention is generally for use with any bluff body vehicle, especially ones having a vertically-oriented rear end base. And while the present discussion centers on semi-trailer trucks having rectangular-shaped bodies and rear end bases, it is appreciated that the present invention may be used with other types of bluff bodied vehicles such as tankers with cylindrical bodies and circular rear end bases, automobiles, train railcars, boats, ships, etc.

### BRIEF DESCRIPTION OF THE DRAWINGS

The accompanying drawings, which are incorporated into and form a part of the disclosure, are as follows:

FIG. 1 is perspective rear view of a semi-trailer truck having a first exemplary embodiment of the articulating base flap apparatus of the present invention having 8 base flaps.

FIG. 2 is perspective rear view of a semi-trailer truck having a second exemplary embodiment of the articulating base flap apparatus of the present invention having 4 base flaps.

FIG. 3 is perspective rear view of a semi-trailer truck having a third exemplary embodiment of the articulating base flap apparatus of the present invention having 16 base flaps.

FIG. 4 is perspective rear view of the articulating base flap apparatus of Claim 2, with the base flaps deployed normal to the air stream for use as an air brake.

FIG. 5 is perspective rear view of the articulating base flap apparatus of Claim 2, with the base flaps deployed to minimize base drag.

FIG. 6 is perspective rear view of the articulating base flap apparatus of Claim 2, with the base flaps asymmetrically deployed.

FIG. 7 is perspective rear view of the articulating base flap apparatus of Claim 2, with the base flaps fully retracted.

FIG. 8a is a schematic top view of an exemplary base flap of the present invention, and illustrating a closed, fully retracted position.

FIG. 8b is a schematic top view similar to Claim 8a, and illustrating the base flap deployed to minimize base drag

FIG. 8c is a schematic top view similar to Claim 8a, and illustrating the base flap deployed in a trailing position parallel to the air stream.

FIG. 8d is a schematic top view similar to Claim 8a, and illustrating the base flap partially deployed into the air stream.

FIG. 8e is a schematic top view similar to Claim 8a, and illustrating the base flap fully deployed in an orthogonal direction to the air stream, to operate as an air brake.

FIG. 9 is a schematic operational flow diagram for controlling the base flaps of the present invention.

### DETAILED DESCRIPTION

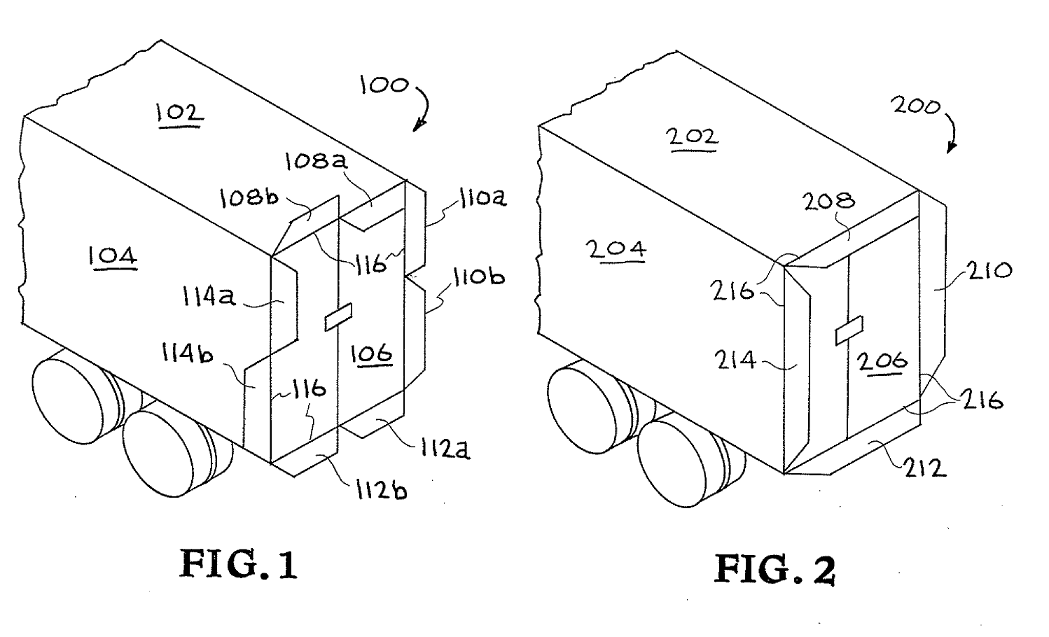

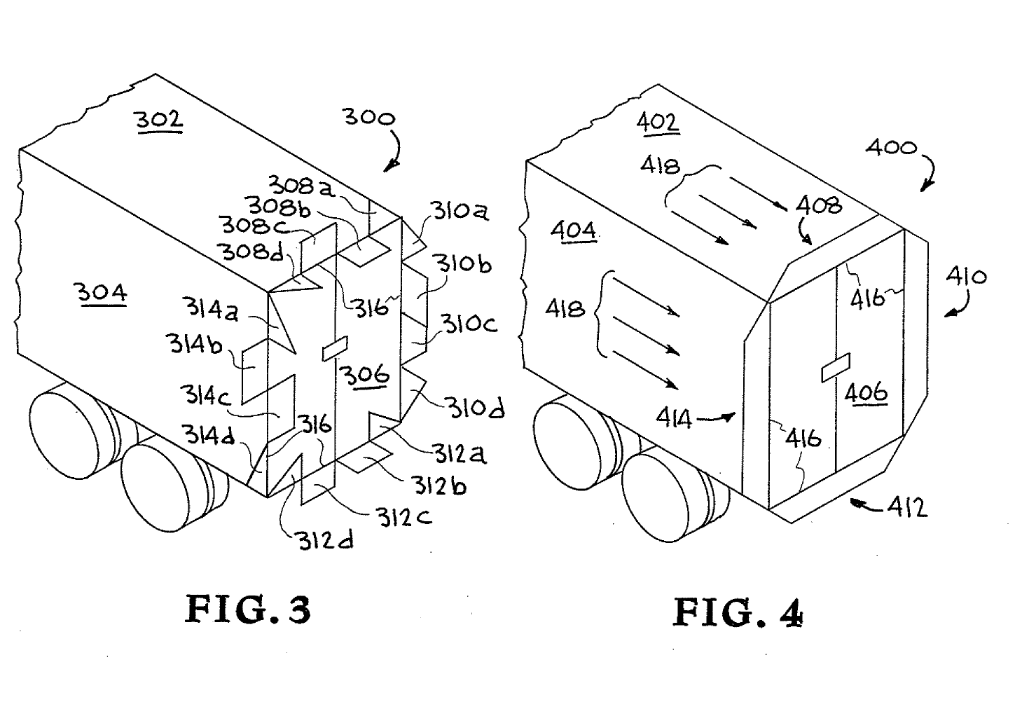

Turning now to the drawings, FIG. 1-3 show three different exemplary embodiments of the articulating base flap apparatus of the present invention mounted on a bluff bodied vehicle, shown as a semi-trailer. In FIG. 1, the articulating base flap apparatus is generally indicated at reference character 100, and includes eight base flaps including top side base flaps 108a,b, right side base flaps 110a,b, bottom side base flaps 112a,b, and left side base flaps 114a,b shown mounted near a rear end base 106 at the trailing end of the vehicle. The vehicle is also shown having a left side 104, a right side (not shown), a top side 102, and a bottom side (not shown), which are connected to the rear end base 106 at a left side edge, a right side edge, a top side edge, and a bottom side edge, respectively, all of which are generally indicated at reference character 116. While each of the base flaps are shown hingedly mounted directly on the edges 116, it is appreciated that the actual mounting locations may be near the edges 116, such as on the rear end base surface or on one of the side surfaces of the vehicle body. In FIG. 2, the articulating base flap apparatus is generally indicated at reference character 200, and includes four base flaps, including a top side base flap 208, a right side base flap 210, a bottom side base flap 212, and a left side base flap 214, which are shown connected to edges 216 joining the rear end base 206 to each of a left side 204, a right side (not shown), a top side 202, and a bottom side (not shown). And in FIG. 3, the articulating base flap apparatus is generally indicated at reference character 300, and includes sixteen base flaps, including top side base flaps 308a-d, right side base flaps 310a-d, bottom side base flaps 312a-d, and left side base flaps 314a-d, which are shown connected to edges 316 joining the rear end base 306 to each of a left side 304, a right side (not shown), a top side 302, and a bottom side (not shown). It is appreciated that the left, right, top, and bottom sides and edges, though shown as part of a rectangular shaped vehicle, may in the alternative be part of non-rectangular shaped vehicles, such as tanker trucks having a cylindrical body and a circular rear end base.

As can be seen in FIGS. 1-3, various numbers of base flaps may be used in the present invention. Preferably, however, the minimum number of base flaps for operation is three, including the a left side base flap, a right side base flap, and a top side base flap, with the left and right side base flaps being substantially vertical and the top side base flap being substantially horizontal in orientation. The bottom side base flap, such as 212 in FIG. 2 may be optionally provided, but may not be as effective as the left, right, and top side base flaps since the rear axle may cause a wake that makes a bottom side base flap less effective.

In each of FIGS. 1-3, a controller (see 904, 906 in FIG. 9) is used to independently actuate the base flaps to a desired position to produce a desired combined aerodynamic drag reducing and/or stabilizing effect on the vehicle in motion. As discussed in the Summary, the controller is generally a controller system of a type known in the art, including actuators and a controller processor for controlling the actuators. And FIG. 9 is a schematic operational flow diagram for controlling the base flaps of the present invention, generally indicated at reference character 900. As shown in FIG. 9, control information, data, or signal 902 is sent and received by a controller processor 904 so that the data is used as the basis for base flap actuation as well as the manner of actuation. In particular, in an exemplary embodiment, the data 902 may be sensor information provided by a sensor (not shown) mounted or otherwise found on the body of the vehicle, and which is adapted to sense a particular vehicle operating condition using a sensor. For example, the sensor may be a speed sensor, a cross-flow sensor, a lift sensor, a yaw sensor, a pitch sensor, and a roll sensor, of a type known in the art. In addition, the sensor may be of a type that detects other vehicle operating conditions, such as brake actuation, acceleration, deceleration, etc. The sensor information is communicated to the controller processor 904, so that the base flap actuation by the controller is based on the sensor information. In another exemplary embodiment, a user input device (not shown) may be employed to receive user input as the data 902 that is communicated to the controller processor 904. Such user input device may be any type known in the art, such as for example, switches or buttons which are operably connected to the controller and individually associated with specified operational modes, or even a computer input device. In any case, FIG. 9 shows the controller processor 904 operably connected to the controller's flap actuating mechanism, (e.g. hydraulic arm), which is in turn connected to the flaps 908 to actuate the flaps to various desired positions.

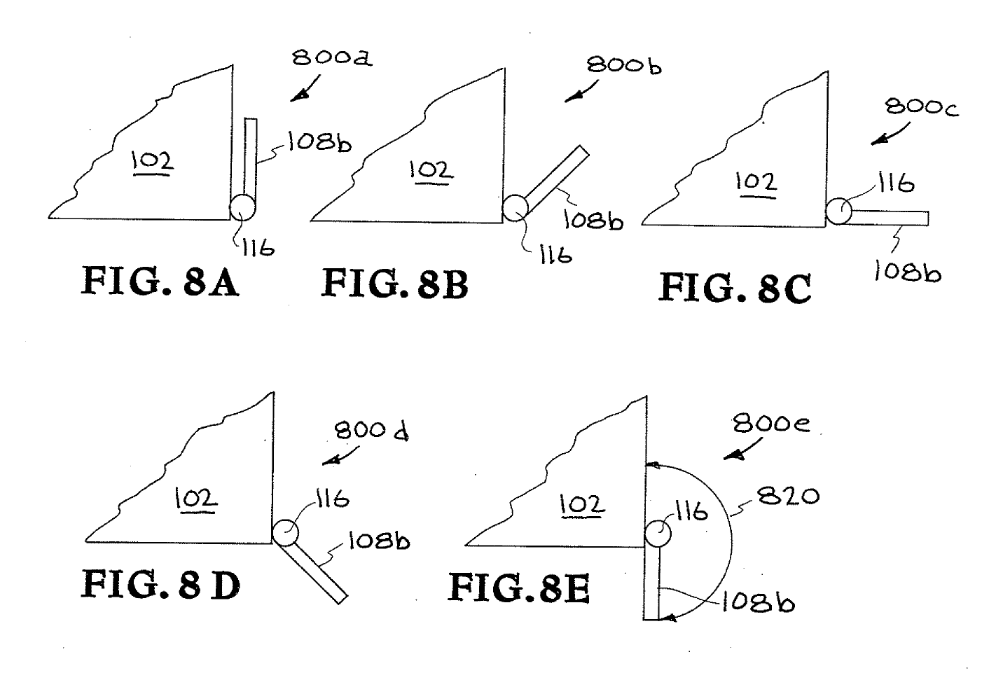

And FIGS. 8a-e show various deflected positions of the base flaps which may be desired for achieving a particular base flap configuration which produces a desired aerodynamic drag reducing or stabilizing effect. In particular, the base flaps are hingedly connected to have a range of motion that can extend from a first position that is subject to direct free stream impingement and a second position that is not subject to direct free stream impingement. FIG. 8a is a schematic top view of an exemplary base flap 108b of the present invention, and illustrating a closed, fully retracted position 800a. The base flap is shown connected by a hinge 116 near a left side edge of the rear end base (as suggested by the viewable top side 102). In this retracted position, the base flap is adjacent substantially flush with the rear end base, so that there is no direct impingement or interaction with the free stream (418 in FIG. 4). FIG. 8b is a schematic top view similar to Claim 8a, and illustrating the base flap 108b now in a deployed position 800b for minimizing base drag. It is appreciated that this position 800b of the base flap operates to contour the edge so that the free stream is directed into a recirculation zone behind the rear end base. FIG. 8c is a schematic top view similar to Claim 8a, and illustrating the base flap 108b deployed in a trailing position parallel to the free stream, also to effect drag reduction. However, it is appreciated that in this position 800c, the base flap is not subject to direct free stream impingement. FIG. 8d is a schematic top view similar to Claim 8a, and illustrating the base flap 108b partially deployed into the free stream at position 800c so that it is now subject to direct impingement of the free stream. And FIG. 8e is a schematic top view similar to Claim 8a, and illustrating the base flap 108b fully deployed in an outwardly directed orthogonal direction to the free stream, to operate as an air brake. The full range of motion of this particular base flap 10b is shown as arc 820. It is appreciated however, that in another exemplary embodiment, the base flap may be positioned to be flush with a side of the vehicle, e.g. the left side in FIG. 8, which would also be considered a retracted position that is not subject to direct free stream impingement.

FIGS. 4-7 show four exemplary operational modes of independent base flap control, for tailoring the performance of the heavy vehicle for a wide variety of operating conditions/functions. In FIGS. 4-7 the four flap embodiment is used for illustration purposes only. In particular, FIG. 4 shows operation of the apparatus in “air brake mode”, generally indicated at 400, where all the base flaps 408, 410, 412, and 414 are deflected (about edges 416) to the same desired position, i.e. an outwardly-directed orthogonal position that is orthogonal/normal to the free stream 418 and is subject to direct impingement by the free stream. This mode is intended for maximizing the drag coefficient of a heavy vehicle in an emergency stop.

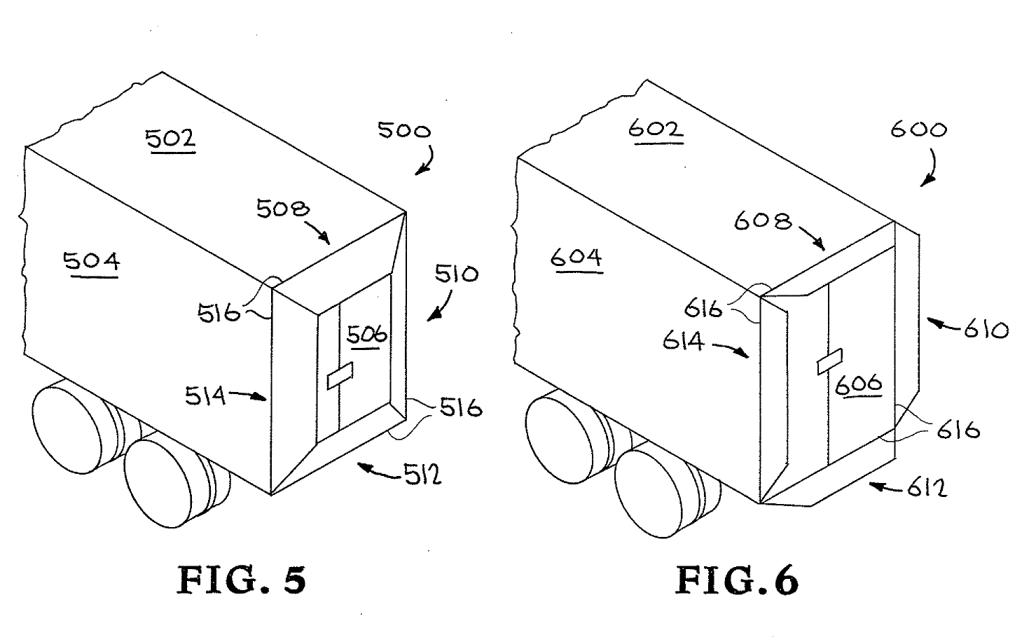

In a “highway travel mode,” shown in FIG. 5, indicated at reference character 500, all the base flaps 508, 510, 514, and 512 are deflected (about edges 516) to the same desired position, i.e. an inwardly-direct angled position that is angled slightly inward toward a central longitudinal axis (not shown) of the vehicle and away from the adjacent free stream. It is notable that in this position, the base flaps are not subject to direct impingement by the free stream and is used for aerodynamic base drag minimization at highway speeds.

In an “asymmetric stability control mode,” shown in FIG. 6, cross-flow conditions can be addressed by deploying the base flaps 608, 610, 612, and 614 in an asymmetric manner, e.g. left-side edge mounted base flap 614 is deflected (about edges 616) in the same direction as right-side edge mounted base flap 610, so as to enhance the stability of the moving vehicle. Alternatively, an asymmetric configuration may be produced by deflecting top and bottom-side edge mounted base flaps in the same direction.

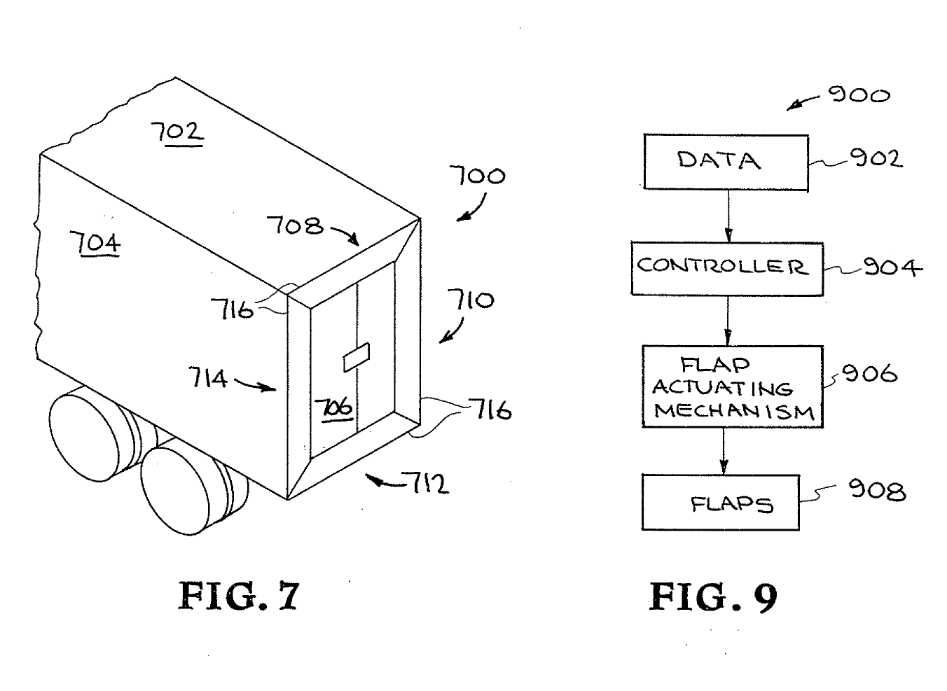

And in a “cargo access mode,” shown in FIG. 7, access to the cargo area of a trailer via the rear end base 706 may be provided during loading and unloading by retracing the base flaps 708, 710, 712, and 714 to be flush with the trailer base surface 706, or flush with the trailer top side, left side, right side, and bottom side (not shown), which in either case places the flap in a position not subject to direct free stream impingement.

While particular embodiments and parameters have been described and/or illustrated, such are not intended to be limiting. Modifications and changes may become apparent to those skilled in the art, and it is intended that the invention be limited only by the scope of the appended claims.

We claim:

1. An aerodynamic base drag reduction and stability control apparatus comprising:
an articulable base flap hingedly connected near an edge of a rear end base of a vehicle; and
a controller operably connected to actuate the base flap to a desired position relative to a free stream adjacent the vehicle in motion to produce a desired aerodynamic drag reducing and/or stabilizing effect on the vehicle in motion.

2. The apparatus of claim 1,
wherein the base flap has a range of motion between a first position subject to direct free stream impingement and a second position not subject to direct free stream impingement.

3. The apparatus of claim 1,
further comprising at least one additional articulable base flap also hingedly connected near an edge of the rear end base of the vehicle, and
wherein the controller is operably connected to independently actuate the base flaps to corresponding desired positions relative to the free stream adjacent the vehicle in motion to produce a desired combined aerodynamic drag reducing and/or stabilizing effect on the vehicle in motion.

4. The apparatus of claim 3,
wherein each of the base flaps have a corresponding range of motion between a first position subject to direct free stream impingement and a second position not subject to direct free stream impingement.

5. The apparatus of claim 1,
further comprising a sensor for sensing a vehicle operating condition and operably connected to communicate sensor information to the controller, and
wherein the base flap actuation by the controller is based on the sensor information.

6. The apparatus of claim 1,
further comprising a user input device operably connected to receive and communicate user control input to the controller, and
wherein the base flap actuation by the controller is based on the user control input.

7. An aerodynamic base drag reduction and stability control apparatus comprising:
a plurality of articulable base flaps each hingedly connected near one of a left side edge, a right side edge, a top side edge, and a bottom side edge of a rear end base of a vehicle so that each of the base flaps have a corresponding range of motion between a first position subject to direct impingement by a free stream adjacent the vehicle in motion and a second position not subject to direct impingement by the free stream; and
a controller operably connected to independently actuate the base flaps to corresponding desired positions relative to the free stream and within the corresponding ranges of motion to produce a desired combined aerodynamic drag reducing and/or stabilizing effect on the vehicle in motion.

8. The apparatus of claim 7,
further comprising a sensor for sensing a vehicle operating condition and operably connected to communicate sensor information to the controller, and
wherein the base flap actuation by the controller is based on the sensor information.

9. The apparatus of claim 7,
further comprising a user input device operably connected to receive and communicate user control input to the controller, and
wherein the base flap actuation by the controller is based on the user control input.

10. A method of reducing aerodynamic base drag on and/or controlling stability of a bluff body vehicle, comprising:
providing an articulable base flap hingedly connected near an edge of a rear end base of a vehicle, and a controller operably connected to actuate the base flap; and
actuating the base flap with the controller to a desired position relative to a free stream adjacent the vehicle in motion to produce a desired aerodynamic drag reducing and/or stabilizing effect on the vehicle when in motion.

11. The method of claim 10,
wherein the base flap has a range of motion between a first position subject to direct free stream impingement and a second position not subject to direct free stream impingement.

12. The method of claim 11,
wherein in the step of actuating the base flap the desired position to which the base flap is actuated is selected from a group consisting of: (1) an outwardly-directed orthogonal position subject to direct impingement of the free stream, (2) a parallel position not subject to direct free stream impingement, (3) an inwardly-directed angled position not subject to direct free stream impingement, and (4) an inwardly-directed retracted position adjacent the rear end base.

13. The method of claim 11, further comprising:
sensing a vehicle operating condition using a sensor; and
communicating sensor information to the controller, so that the base flap actuation by the controller is based on the sensor information.

14. The method of claim 11, further comprising:
receiving user control input using a user input device; and
communicating the user control input to the controller, so that the base flap actuation by the controller is based on the user control input.

15. A method of reducing aerodynamic base drag and/or controlling stability of a bluff body vehicle, comprising:
providing a plurality of articulable base flaps each hingedly connected near one of a left side edge, a right side edge, a top side edge, and a bottom side edge of a rear end base of a vehicle so that each of the base flaps have a corresponding range of motion between a first position subject to direct impingement by a free stream adjacent the vehicle in motion and a second position not subject to direct impingement by the free stream, and a controller for independently actuating the base flaps; and
independently actuating the base flaps with the controller to corresponding desired positions relative to the free stream and within the corresponding ranges of motion to produce a desired combined aerodynamic drag reducing and/or stabilizing effect on the vehicle in motion.

16. The method of claim 15,
wherein in the step of independently actuating the base flaps, all the base flaps are actuated to a same desired position selected from a group consisting of: (1) an outwardly-directed orthogonal position subject to direct impingement of the free stream, (2) a parallel position not subject to direct free stream impingement, (3) an inwardly-directed angled position not subject to direct free stream impingement, and (4) an inwardly-directed retracted position adjacent the rear end base.

17. The method of claim 15,
wherein in the step of independently actuating the base flaps, base flaps connected near opposite left/right or opposite top/bottom sides are actuated in the same direction as each other, to produce an asymmetric base flap configuration.

18. The method of claim 15, further comprising:
sensing a vehicle operating condition using a sensor; and
communicating sensor information to the controller, so that the independent base flap actuation by the controller is based on the sensor information.

19. The method of claim 15, further comprising:
receiving user control input using a user input device; and
communicating the user control input to the controller, so that the independent base flap actuation by the controller is based on the user control input.
